(19) United States
(12) Patent Application Publication
(10) Pub. No.: US 2018/0356099 A1
(43) Pub. Date: Dec. 13, 2018

(54) BULK SWIRL ROTATING DETONATION PROPULSION SYSTEM

(71) Applicant: General Electric Company, Schenectady, NY (US)

(72) Inventors: Joseph Zelina, Waynesville, OH (US); Sibtosh Pal, Mason, OH (US); Arthur Wesley Johnson, Cincinnati, OH (US); Clayton Stuart Cooper, Loveland, OH (US); Steven Clayton Vise, Loveland, OH (US)

(21) Appl. No.: 15/618,326

(22) Filed: Jun. 9, 2017

(51) Int. Cl. F23R 3/56; F01D 9/04; F02C 5/02; F02C 7/22; F23R 3/28

(52) U.S. Cl. CPC F23R 3/56; F01D 9/041; F02C 5/02; F05D 2240/35; F23R 3/286; F05D 2220/32; F02C 7/222

(57) ABSTRACT

The present disclosure is directed to a propulsion system including a rotating detonation combustion (RDC) system defining a plurality of fuel-oxidizer mixing nozzles each defined by a converging-diverging nozzle wall defining a nozzle flowpath. The nozzle wall defines a throat and a lengthwise direction extended between a nozzle inlet and nozzle outlet along the lengthwise direction. The longitudinal centerline of the propulsion system and the radial direction together define a reference plane, and the lengthwise direction of the nozzle intersects the reference plane and defines a nozzle angle greater than zero degrees and approximately 80 degrees or less relative to the reference plane.

### FIELD

The present subject matter relates generally to a system and method of continuous detonation in an engine.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. The pulsed mode design involves one or more detonation tubes, whereas the continuous mode is based on a geometry, typically an annulus, within which single or multiple detonation waves spin. For both types of modes, high energy ignition detonates a fuel/air mixture that transitions into a detonation wave (i.e., a fast moving shock wave closely coupled to the reaction zone). The detonation wave travels in a Mach number range greater than the speed of sound (e.g., Mach 4 to 8) with respect to the speed of sound of the reactants. The products of combustion follow the detonation wave at the speed of sound relative to the detonation wave and at significantly elevated pressure. Such combustion products may then exit through a nozzle to produce thrust or rotate a turbine.

Although detonation combustors may generally provide improved efficiency and performance, there exists a need for propulsion systems further integrating a detonation combustion system that may improve propulsion system efficiency and performance.

### BRIEF DESCRIPTION

Aspects and advantages of the invention will be set forth in part in the following description, or may be obvious from the description, or may be learned through practice of the invention.

The present disclosure is directed to a propulsion system defining a radial direction extended from a longitudinal centerline extended along a longitudinal direction, and a circumferential direction relative to the longitudinal centerline. The propulsion system includes a rotating detonation combustion (RDC) system defining a plurality of fuel-oxidizer mixing nozzles each defined by a converging-diverging nozzle wall defining a nozzle flowpath. The nozzle wall defines a throat and a lengthwise direction extended between a nozzle inlet and nozzle outlet along the lengthwise direction. The longitudinal centerline of the propulsion system and the radial direction together define a reference plane, and the lengthwise direction of the nozzle intersects the reference plane and defines a nozzle angle greater than zero degrees and approximately 80 degrees or less relative to the reference plane.

In various embodiments, the RDC system further includes an annular outer wall defining at least in part a combustion chamber downstream of the plurality of nozzles. In one embodiment, the RDC system defines the outer wall generally concentric to the longitudinal centerline of the propulsion system. In another embodiment, the propulsion system further includes a turbine nozzle disposed downstream of the combustion chamber. The turbine nozzle includes a plurality of turbine nozzle airfoils defining an exit angle relative to the reference plane.

In one embodiment, the exit angle of the plurality of turbine nozzle airfoils is configured to a desired circumferential direction relative to an exhaust section of the propulsion system. In another embodiment, the exit angle and the nozzle angle are within approximately 20 degrees relative to one another. In still another embodiment, the exit angle and the nozzle angle are approximately equal. In yet another embodiment, the plurality of turbine nozzle airfoils defines a turbine nozzle inlet angle in which the inlet angle is less than or approximately equal to the exit angle. In still yet another embodiment, the plurality of turbine nozzle airfoils defines a turbine nozzle inlet angle in which the turbine nozzle inlet angle is approximately equal to or less than the nozzle angle.

In various embodiments, the RDC system defines an RDC inlet comprising a plurality of RDC inlet airfoils defining an inlet angle relative to the reference plane. In one embodiment, the inlet angle of the RDC inlet airfoils is greater than zero degrees and approximately 80 degrees or less relative to the reference plane. In another embodiment, the inlet angle and the nozzle angle are within approximately 20 degrees relative to one another.

In one embodiment of the propulsion system, each nozzle of the RDC system further defines a fuel injection port disposed approximately at the throat of each nozzle, wherein the fuel injection port is configured to flow a fuel to the nozzle flowpath.

The present disclosure is further directed to a gas turbine engine defining a radial direction extended from a longitudinal centerline extended along a longitudinal direction, and a circumferential direction relative to the longitudinal centerline. The gas turbine engine includes a rotating detonation combustion (RDC) system defining a plurality of fuel-oxidizer mixing nozzles each defined by a converging-diverging nozzle wall defining a nozzle flowpath. The nozzle wall defines a throat and a lengthwise direction extended between a nozzle inlet and nozzle outlet along the lengthwise direction. The longitudinal centerline of the propulsion system and the radial direction together define a reference plane, and the lengthwise direction of the nozzle intersects the reference plane and defines a nozzle angle greater than zero degrees and approximately 80 degrees or less relative to the reference plane. The RDC system further defines an annular outer wall defining at least in part a combustion chamber downstream of the plurality of nozzles, and the combustion chamber defines a combustion inlet proximate to the plurality of nozzles and a combustion outlet downstream thereof. The gas turbine engine further includes a first turbine rotor at the combustion outlet of the RDC system, in which the first turbine rotor is in direct fluid communication with the combustion chamber.

In one embodiment of the gas turbine engine, the nozzle angle is greater than approximately 65 degrees and less than approximately 80 degrees, inclusively.

In another embodiment of the gas turbine engine, each nozzle of the RDC system further defines a fuel injection port disposed approximately at the throat of each nozzle. The fuel injection port is configured to flow a fuel to the nozzle flowpath.

In still another embodiment of the gas turbine engine, the first turbine rotor is configured to rotate co-directional to a direction of bulk swirl of fuel/oxidizer mixture.

In various embodiments of the gas turbine engine, the RDC system defines an RDC inlet comprising a plurality of RDC inlet airfoils defining an inlet angle relative to the reference plane. In one embodiment, the inlet angle of the RDC inlet airfoils is greater than zero degrees and approximately 80 degrees or less relative to the reference plane. In another embodiment, the inlet angle and the nozzle angle are within approximately 20 degrees relative to one another

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a propulsion system in accordance with an exemplary embodiment of the present disclosure;

FIG. 2 is a cross sectional view of an exemplary embodiment of a portion of the propulsion system generally provided in FIG. 1;

FIG. 3 is an exemplary embodiment of a combustion chamber of a rotating detonation combustion system in accordance with an embodiment of the present disclosure;

FIG. 4 is an exemplary embodiment of the propulsion system of FIG. 1 defining direct fluid communication of combustion gases from a combustion chamber to a first turbine rotor in accordance with an exemplary embodiment of the present disclosure;

FIG. 5 is a cross sectional view of another exemplary embodiment of a portion of the propulsion system generally provided in FIG. 1;

FIG. 6 is a cross sectional view of yet another exemplary embodiment of a portion of the propulsion system generally provided in FIG. 1;

FIG. 7 is a cross sectional view of still another exemplary embodiment of a portion of the propulsion system generally provided in FIG. 1;

FIG. 8 is a cross-sectional view of a forward end of a rotating detonation combustion system in accordance with an exemplary embodiment of the present disclosure; and

FIG. 9 is a cross-sectional view of a forward end of a rotating detonation combustion system in accordance with another exemplary embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Embodiments of a propulsion system including a bulk swirl rotating detonation combustion (RDC) system are generally provided herein that may increase a bulk swirl of combustion gases within the combustion chamber of the RDC system, thereby improving propulsion system efficiency and performance. The bulk swirl may reduce a length of the turbine nozzle or altogether eliminate the turbine nozzle, thereby enabling direct fluid communication of the combustion gases from the combustion chamber to a first turbine rotor. Reducing the length of or eliminating the turbine nozzle may improve overall propulsion system efficiency and performance, such as by reducing part counts, length, weight, and improving thermodynamic efficiency by reducing an amount of cooling oxidizer removed from combustion and energy release.

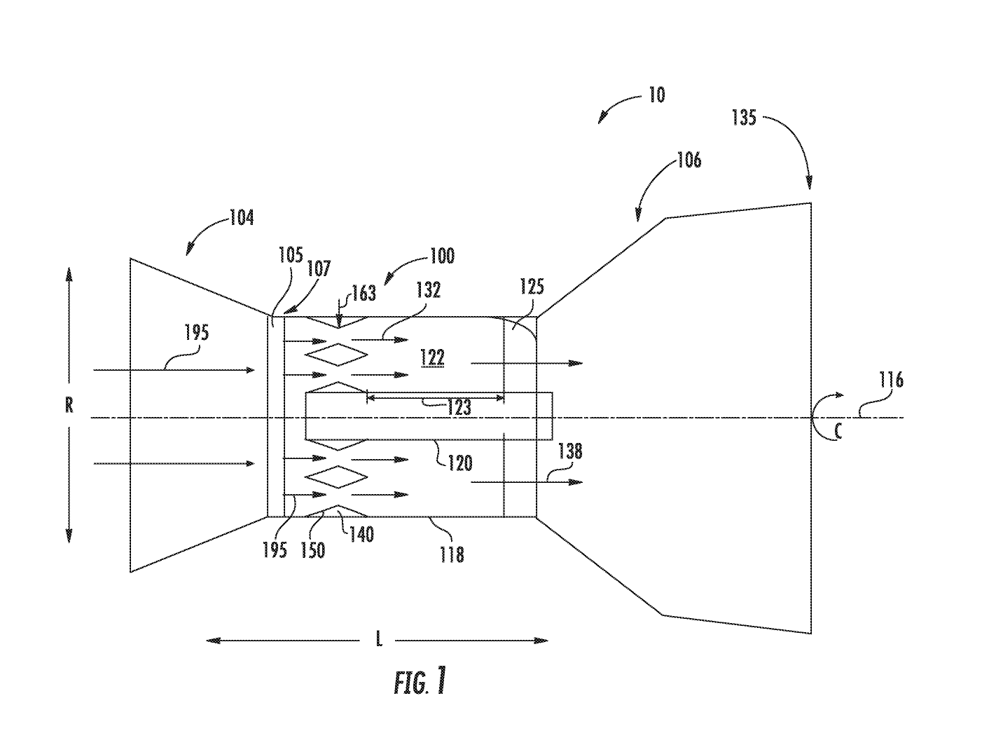

Referring now to the figures, FIG. 1 depicts a propulsion system 10 including a rotating detonation combustion system 100 (an “RDC system”) in accordance with an exemplary embodiment of the present disclosure. The propulsion system 10 generally includes an inlet section 104 and an outlet section 106. In one embodiment, the RDC system 100 is located downstream of the inlet section 104 and upstream of the exhaust section 106. In various embodiments, the propulsion system 10 defines a gas turbine engine, a ramjet, or other propulsion system including a fuel-oxidizer burner producing combustion products that provide propulsive thrust or mechanical energy output. In an embodiment of the propulsion system 10 defining a gas turbine engine, the inlet section 104 includes a compressor section defining one or more compressors generating a flow of oxidizer 195 to the RDC system 100. The inlet section 104 may generally guide a flow of the oxidizer 195 to the RDC system 100. The inlet section 104 may further compress the oxidizer 195 before it enters the RDC system 100. The inlet section 104 defining a compressor section may include one or more alternating stages of rotating compressor airfoils. In other embodiments, the inlet section 104 may generally define a decreasing cross sectional area from an upstream end to a downstream end proximate to the RDC system 100.

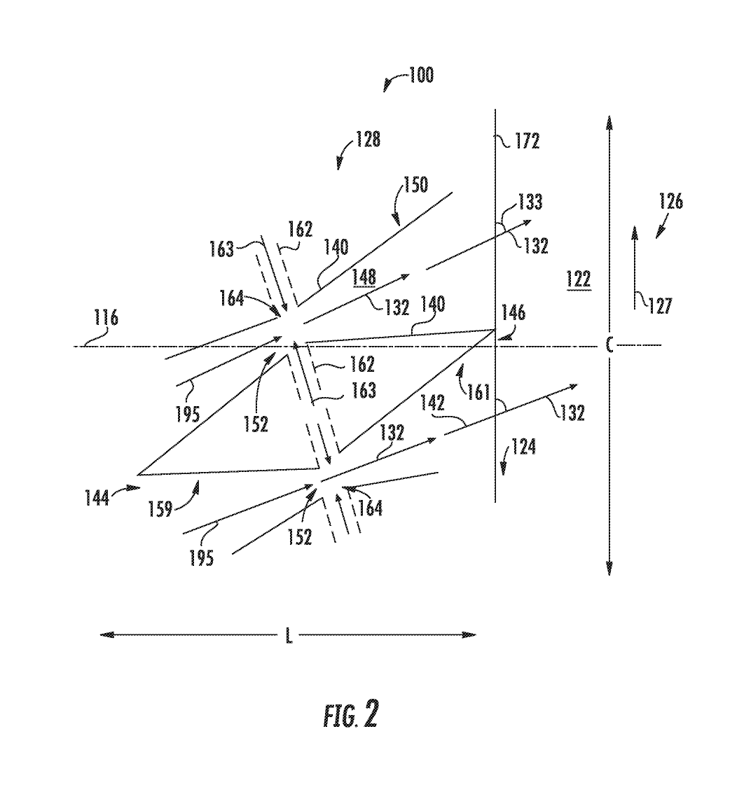

As will be discussed in further detail below, at least a portion of the flow of oxidizer 195 is mixed with a fuel 163 (shown in FIG. 2) and combusted to generate combustion products 138. The combustion products 138 flow downstream to the exhaust section 106. In various embodiments, the exhaust section 106 may generally define an increasing cross sectional area from an upstream end proximate to the RDC system 100 to a downstream end of the propulsion system 10. Expansion of the combustion products 138 generally provides thrust that propels the apparatus to which the propulsion system 10 is attached, or provides mechanical energy to one or more turbines further coupled to a fan section, a generator, or both. Thus, the exhaust section 106 may further define a turbine section of a gas turbine engine including one or more alternating rows or stages of rotating turbine airfoils. The combustion products 138 may flow from the exhaust section 106 through, e.g., an exhaust nozzle 135 to generate thrust for the propulsion system 10.

As will be appreciated, in various embodiments of the propulsion system 10 defining a gas turbine engine, rotation of the turbine(s) within the exhaust section 106 generated by the combustion products 138 is transferred through one or more shafts or spools to drive the compressor(s) within the inlet section 104. In various embodiments, the inlet section 104 may further define a fan section, such as for a turbofan engine configuration, such as to propel air across a bypass flowpath outside of the RDC system 100 and exhaust section 106.

It will be appreciated that the propulsion system 10 depicted schematically in FIG. 1 is provided by way of example only. In certain exemplary embodiments, the propulsion system 10 may include any suitable number of compressors within the inlet section 104, any suitable number of turbines within the exhaust section 106, and further may include any number of shafts or spools appropriate for mechanically linking the compressor(s), turbine(s), and/or fans. Similarly, in other exemplary embodiments, the propulsion system 10 may include any suitable fan section, with a fan thereof being driven by the exhaust section 106 in any suitable manner. For example, in certain embodiments, the fan may be directly linked to a turbine within the exhaust section 106, or alternatively, may be driven by a turbine within the exhaust section 106 across a reduction gearbox. Additionally, the fan may be a variable pitch fan, a fixed pitch fan, a ducted fan (i.e., the propulsion system 10 may include an outer nacelle surrounding the fan section), an un-ducted fan, or may have any other suitable configuration.

Moreover, it should also be appreciated that the RDC system 100 may further be incorporated into any other suitable aeronautical propulsion system, such as a turboshaft engine, a turboprop engine, a turbojet engine, a ramjet engine, a scramjet engine, etc. Further, in certain embodiments, the RDC system 100 may be incorporated into a non-aeronautical propulsion system, such as a land-based or marine-based power generation system. Further still, in certain embodiments, the RDC system 100 may be incorporated into any other suitable propulsion system, such as a rocket or missile engine. With one or more of the latter embodiments, the propulsion system may not include a compressor in the inlet section 104 or a turbine in the exhaust section 106.

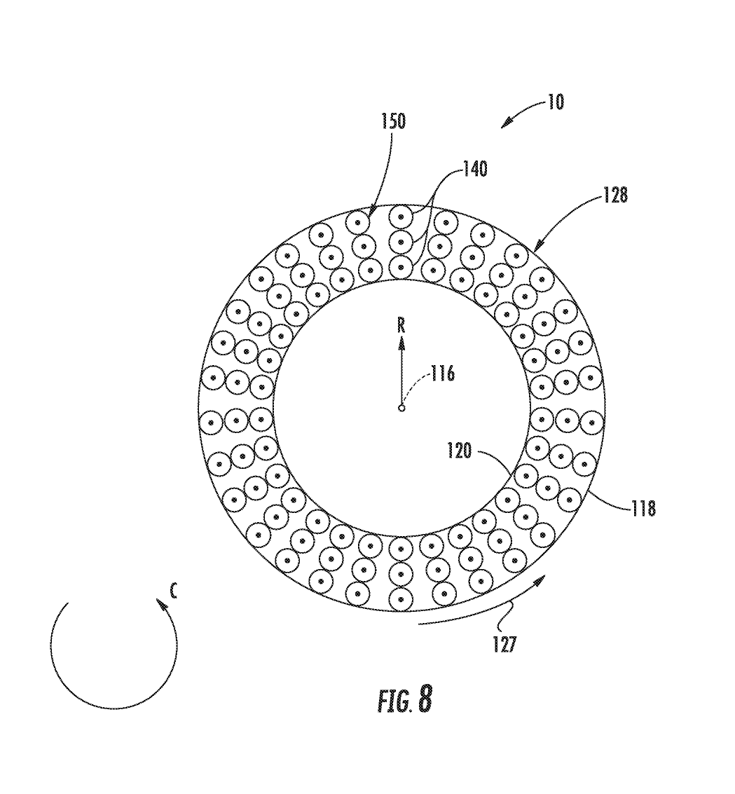

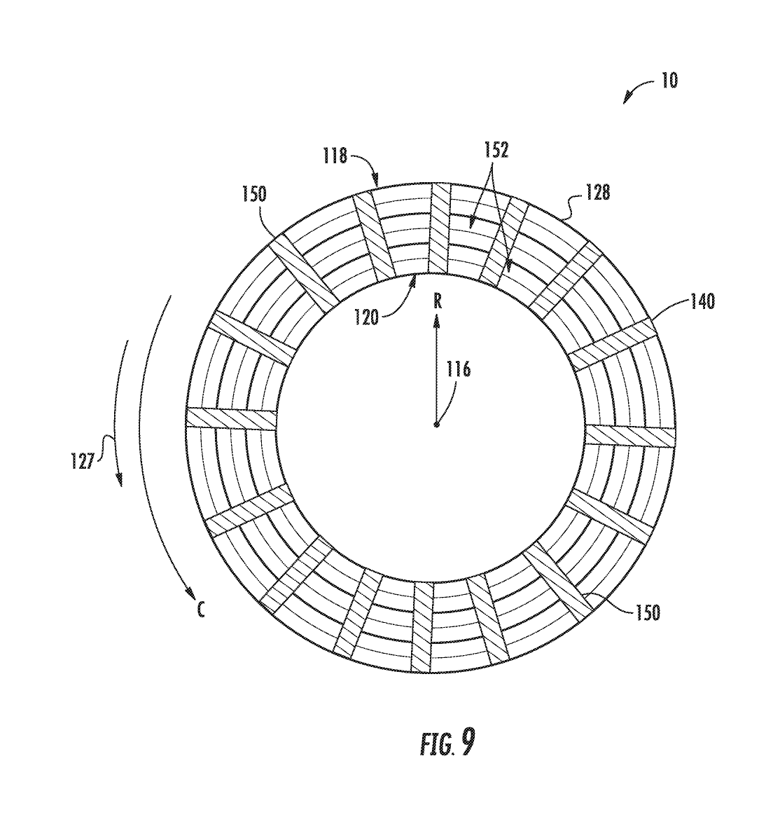

Referring still to FIG. 1, the RDC system 100 includes a generally cylindrical outer wall 118 concentric to the longitudinal centerline 116 of the propulsion system 10. The outer wall 118 defines, at least in part, a combustion chamber 122. The RDC system 100 may further include a generally cylindrical inner wall 120 (shown in FIGS. 8-9) radially inward of the outer wall 118 and concentric to the longitudinal centerline 116. In various embodiments, the outer wall 118 and inner wall 120 together define the combustion chamber 122.

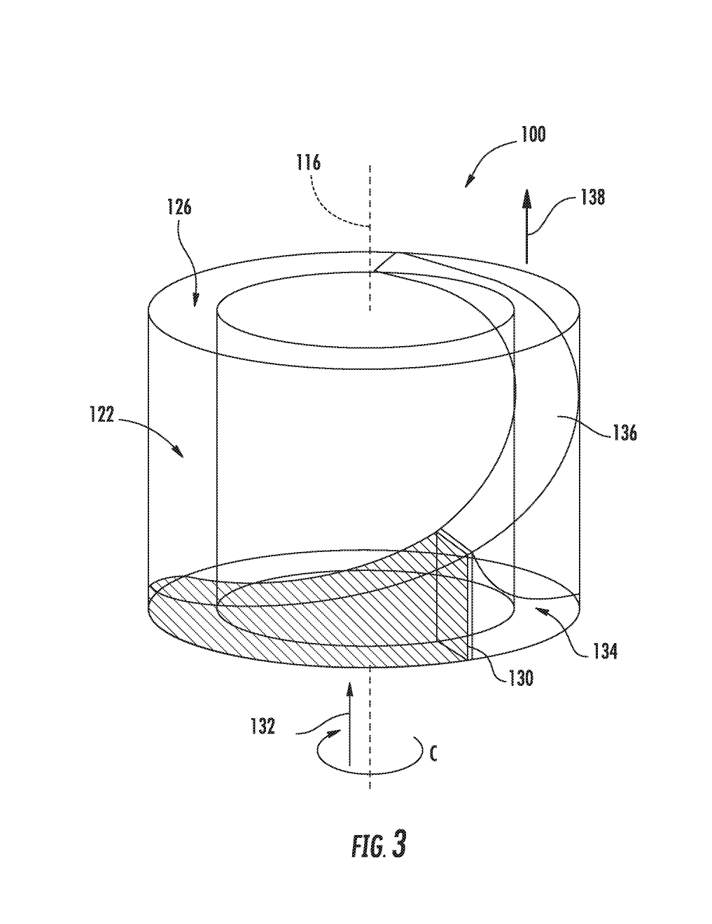

Referring now to FIGS. 1-2, the combustion chamber 122 defines a volume (i.e., defined by a combustion chamber length and combustion chamber width or annular gap) from a combustion chamber inlet 124 proximate to a nozzle assembly 128 and a combustion chamber outlet 126 proximate to the exhaust section 106. The nozzle assembly 128 provides a flow of oxidizer 195 and mixes the oxidizer 195 with a liquid or gaseous fuel 163 to provide a fuel/oxidizer mixture 132 to the combustion chamber 122. The fuel/oxidizer mixture 132 is detonated within the combustion chamber 122 to generate combustion products 138, or more specifically, a detonation wave 130, as discussed in regard to FIG. 3. The combustion products 138 exit through the combustion chamber outlet 126 to the exhaust section 106.

The nozzle assembly 128 is defined at the upstream end of the combustion chamber 122 at the combustion chamber inlet 124. The nozzle assembly 128 generally defines a nozzle inlet 144, a nozzle outlet 146 adjacent to the combustion chamber inlet 124, and a throat 152 between the nozzle inlet 144 and the nozzle outlet 146. A nozzle flowpath 148 is defined from the nozzle inlet 144 through the throat 152 and the nozzle outlet 146.

The nozzle assembly 128 defines a plurality of nozzles 140 each defined by a nozzle wall 150. Each nozzle 140, or more specifically, the nozzle wall 150, generally defines a converging-diverging nozzle, i.e. each nozzle 140 defines a decreasing cross sectional area along a converging area 159 from approximately the nozzle inlet 144 to approximately the throat 152, and further defines an increasing cross sectional area along a diverging area 161 from approximately the throat 152 to approximately the nozzle outlet 146.

Between the nozzle inlet 144 and the nozzle outlet 146, a fuel injection port 162 is defined in fluid communication with the nozzle flowpath 148 through which the oxidizer 195 flows. The fuel injection port 162 introduces a liquid or gaseous fuel 163 (or mixture thereof) to the flow of oxidizer 195 through a fuel port outlet 164 to produce the fuel/oxidizer mixture 132. In various embodiments, the fuel injection port 162 is disposed at approximately the throat 152 of the nozzle assembly 128. Each nozzle 140 may include a plurality of fuel injection ports 162 and fuel port outlets 164 disposed around the throat 152 of each nozzle 140.

Referring briefly to FIG. 3, providing a perspective view of the combustion chamber 122 (without the nozzle assembly 128), it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., combustion products) exits the combustion chamber 122 and is exhausted.

More particularly, it will be appreciated that the RDC system 100 is of a detonation-type combustor, deriving energy from the continuous detonation wave 130 of detonation. For a detonation combustor, such as the RDC system 100 disclosed herein, the combustion of the fuel/oxidizer mixture 132 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the combustion contributes to the propagation of the detonation wave 130. Further, with continuous detonation, the detonation wave 130 propagates around the combustion chamber 122 in a continuous manner, operating at a relatively high frequency. Additionally, the detonation wave 130 may be such that an average pressure inside the combustion chamber 122 is higher than an average pressure within typical combustion systems (i.e., deflagration combustion systems). Accordingly, the region 134 behind the detonation wave 130 has very high pressures.

Referring back to FIG. 2, each nozzle 140, or more specifically, the nozzle wall 150, defines a lengthwise direction 142 extended between the nozzle inlet 144 and the nozzle outlet 146. The longitudinal centerline 116 of the propulsion system 10 and the radial direction R together define a reference plane 172. The lengthwise direction 142 of the nozzle 140 intersects the reference plane 172 and defines a nozzle angle 133 relative to the reference plane 172. In various embodiments, the nozzle 140 defines the nozzle angle 133 greater than zero degrees and approximately 80 degrees or less relative to the reference plane 172. In one embodiment, the nozzle angle 133 is greater than approximately 20 degrees and less than approximately 80 degrees (inclusively) relative to the reference plane 172. In still another embodiment, the nozzle angle 133 is greater than approximately 65 degrees and less than approximately 80 degrees (inclusively) relative to the reference plane 172.

The nozzle 140 defining the nozzle angle 133 generally produces a bulk swirl of the combustion gases 138 at least partially along the circumferential direction C relative to the longitudinal centerline 116. The nozzle angle 133 is disposed co-directional to the detonation wave 130. For example, a schematic reference arrow 127 indicates the direction of the bulk swirl of a fuel/oxidizer mixture 132 egressing the nozzle assembly 128. The nozzle angle 133 is disposed, at least along the circumferential direction C, co-directional to the direction 127 of the bulk swirl of the fuel/oxidizer mixture 132 (further shown in FIG. 3). A detonation wave 130 (shown in FIG. 3) produced from combustion of the fuel/oxidizer mixture 132 may be disposed co-directional to the direction 127 of the bulk swirl at least along the circumferential direction C. The bulk swirl of combustion gases 138 produced by the nozzle assembly 128 may eliminate a need for a turbine nozzle downstream of the combustion chamber 122 and upstream of a first turbine rotor. As such, the RDC system 100 may further improve propulsion system 10 efficiency by removing a structure (i.e., the turbine nozzle) that generally requires a portion of oxidizer to be re-appropriated from combustion (i.e., removed from oxidizer 195 mixed with fuel 163 to produce combustion products 138) and allocated for cooling purposes, thereby not contributing to the combustion products 138 and energy release driving an apparatus to which the propulsion system 10 is attached.

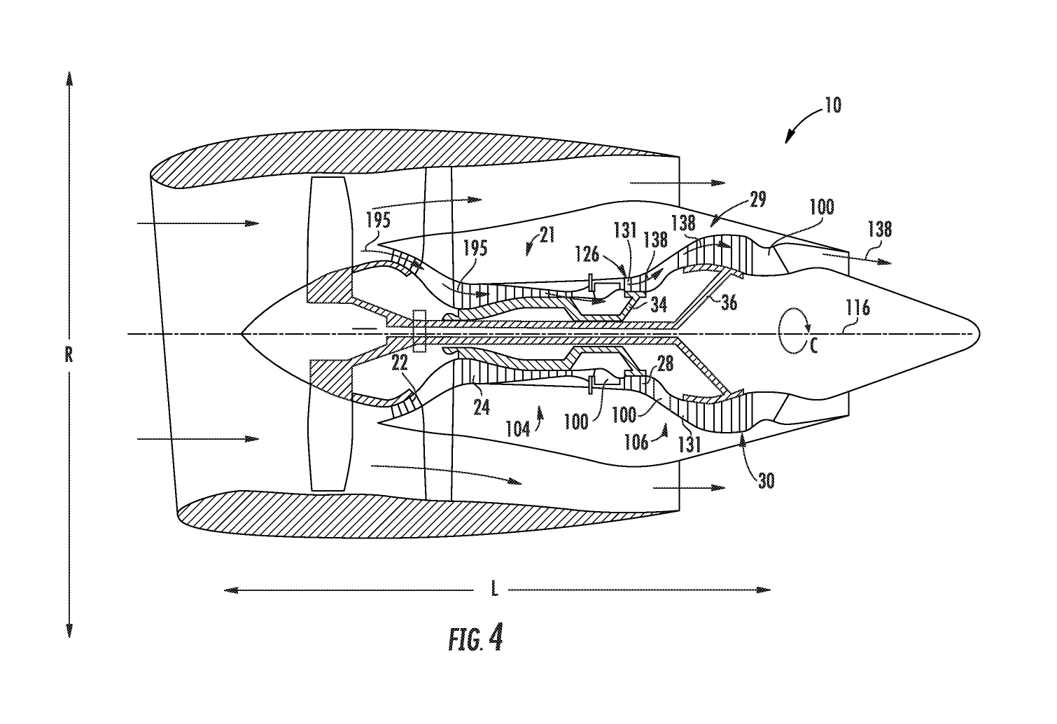

For example, in one embodiment of the propulsion system 10 such as generally provided in FIG. 4 as a gas turbine engine, the propulsion system 10 includes an inlet section 104 defining a compressor section 21 and an exhaust section 106 defining a turbine section 29. One or more turbines 28, 30 of the turbine section 29 are coupled to one or more compressors 22, 24 of the compressor section 21. The propulsion system 10 defining a gas turbine engine may further include a fan assembly 14 coupled to one of the turbines (e.g., a low pressure turbine 30 of the turbine section 29) via a low pressure shaft 36. In the embodiment shown, the low pressure turbine 30 is further coupled to a low pressure compressor 22. Similarly, a high pressure turbine 28 is coupled to a high pressure turbine 24 of the compressor section 21 via a high pressure shaft 34.

More particularly, the propulsion system 10 defines a first turbine rotor 131 at the combustion outlet 126 of the RDC system 100. The first turbine rotor 131 is in direct fluid communication with the combustion chamber 122 (shown in FIG. 2) of the RDC system 100. For example, as previously mentioned, the nozzle assembly 128 provides a bulk swirl of combustion gases 138 exiting the RDC system 100 to enable removal or elimination of a turbine nozzle or other static structure between the RDC system 100 and the first turbine rotor 131 of the exhaust section 106 defining a turbine section 29. As such, the bulk swirl RDC system 100 may enable decreasing the length of the propulsion system 10, thereby reducing an amount of oxidizer removed from combustion for cooling purposes, reduced part counts thereby reducing costs and mitigating propulsion system failures, and reduced propulsion system packaging, thereby decreasing weight and improving fuel efficiency of the propulsion system 10 and the apparatus to which it is attached.

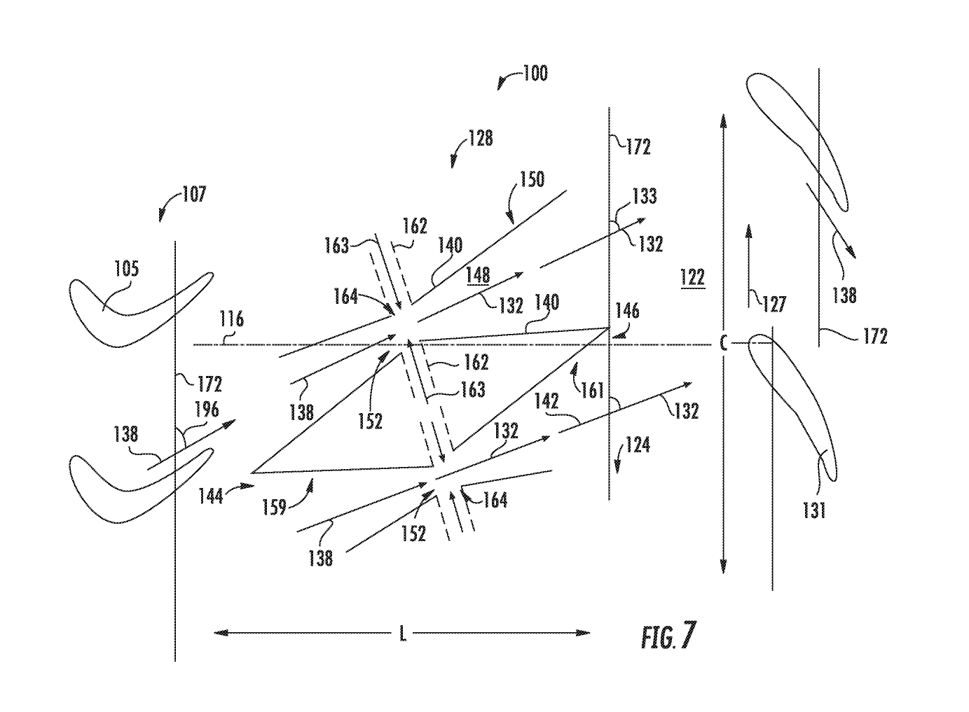

In various embodiments, the first turbine rotor 131 may define a first rotating stage of the high pressure turbine 28 of the turbine section 29. In one embodiment, such as further depicted in FIG. 7, the first turbine rotor 131 is configured to rotate around the longitudinal centerline 116 co-directional to a circumferential component of the nozzle angle 133 defining the circumferential direction 127 of bulk swirl flow of fuel/oxidizer mixture 132.

Although generally shown as a turbofan gas turbine engine, the exemplary embodiment of the propulsion system 10 shown in FIG. 4 may be configured as a turbojet, turboprop, or turboshaft gas turbine engine, as well as industrial and marine gas turbine engines, and auxiliary power units.

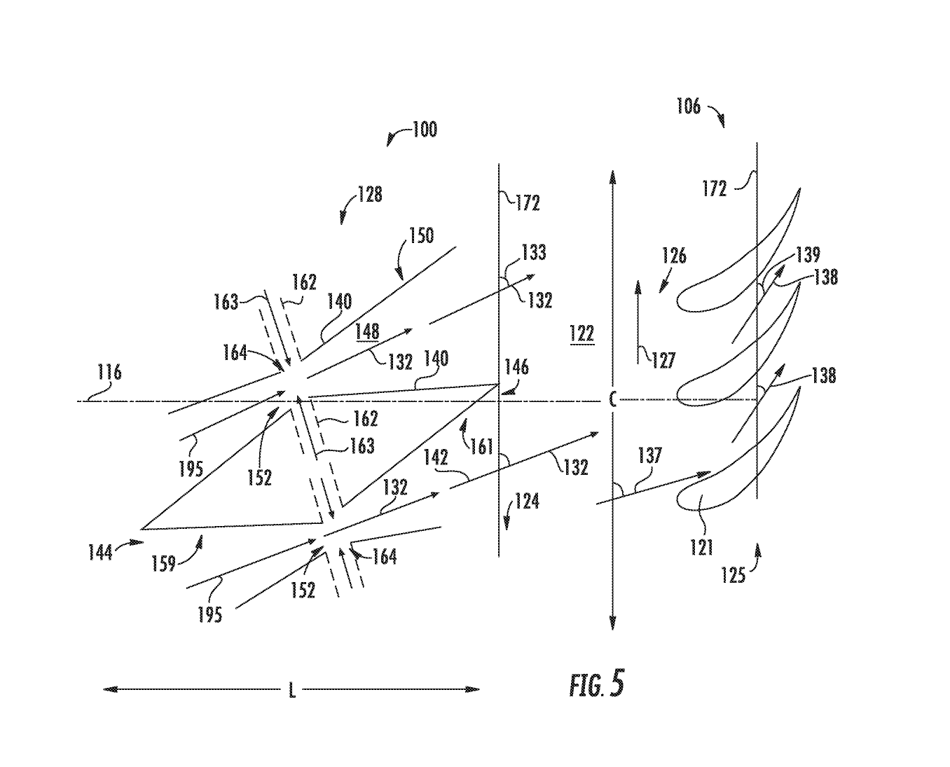

Referring now to FIG. 5, another exemplary portion of the propulsion system 10 is generally provided. The nozzle assembly 128 provided in FIG. 4 is configured substantially similarly to that shown and described in regard to FIGS. 1-3. However, in FIG. 4, a turbine nozzle 125 is further provided at the downstream end of the combustion chamber 122 or at the exhaust section 106. The turbine nozzle 125 includes a plurality of turbine nozzle airfoils 121. The plurality of turbine nozzle airfoils 121 each defines an exit angle 139 relative to the reference plane 172. The exit angle 139 is generally configured to at least a desired circumferential direction relative to the exhaust section 106. For example, the desired circumferential direction may be based on one or more rotors (e.g., turbine rotors) defined downstream of the turbine nozzle 125. The exit angle 139 may generally be configured to reduce or mitigate a normal force of combustion gases 138 acting upon the downstream rotor.

In one embodiment, the exit angle 139 of the plurality of turbine nozzle airfoils 121 is approximately 80 degrees or less relative to the reference plane 172. In another embodiment, the exit angle 139 is between approximately 65 and approximately 80 degrees relative to the reference plane 172. In yet another embodiment, the exit angle 139 is between approximately 70 and approximately 80 degrees relative to the reference plane 172. In another embodiment, the exit angle 139 and the nozzle angle 133 are within approximately 20 degrees relative to one another. In still another embodiment, the exit angle 139 and the nozzle angle 133 are approximately equal.

The turbine nozzle 125, or more specifically, the plurality of turbine nozzle airfoils 121, may further define a turbine nozzle inlet angle 137 relative to the reference plane 172. In one embodiment, the inlet angle 137 is less than or approximately equal to the exit angle 139. In another embodiment, the inlet angle 137 is approximately equal to or less than the nozzle angle 133. For example, the nozzle assembly 128 defining the nozzle angle 133 may induce a bulk swirl of the fuel/oxidizer mixture 132 through the combustion chamber 122. The combustion gases 138 may at least partially flow at least along the circumferential direction C co-directional to the bulk swirl of the fuel/oxidizer mixture 132. However, losses may incur along the longitudinal direction L such that the combustion gases 138 approach the inlet angle 137 of the turbine nozzle 125 less than the nozzle angle 133. The turbine nozzle 125 may accelerate the flow of combustion gases 138 along the circumferential direction C across the turbine nozzle 125, egressing the turbine nozzle 125 at approximately the exit angle 139. In various embodiments, the inlet angle 137 is approximately equal to or less than the nozzle angle 133, the exit angle 139, or both. In still various embodiments, the exit angle 139 is approximately 80 degrees or less relative to the reference plane 172. As such, the nozzle angle 133 may be approximately 80 degrees or less, and the inlet angle 137 of the turbine nozzle 125 may be approximately equal to a bulk swirl angle at the upstream end of the turbine nozzle 125, such as due to losses as the combustion gases 138 flow along the longitudinal direction L.

The nozzle assembly 128 generally provided in FIG. 5 may enable a reduced length (i.e., along the longitudinal direction L) of the turbine nozzle 125, thereby decreasing an amount of oxidizer utilized for cooling purposes and reducing propulsion system weight and, as such, increasing propulsion system efficiency. For example, inducing the bulk swirl of the fuel/oxidizer mixture 133 through the combustion chamber 122 reduces a difference between an angle of the bulk swirl, generally corresponding at least to approximately the nozzle angle 133 or less, and the inlet angle 137 and desired exit angle 139 of the turbine nozzle 125. As such, a difference between the inlet angle 137 and the exit angle 139 may be reduced such that a length of the turbine nozzle 125 along the longitudinal direction L may be reduced. Such reduction in length may therefore decrease an amount of the turbine nozzle 125 exposed to combustion gases 138, thereby reducing an amount of oxidizer utilized for cooling purposes, reducing weight of the turbine nozzle 125, and reducing a length of the propulsion system 10, thereby further reducing weight and increasing efficiency.

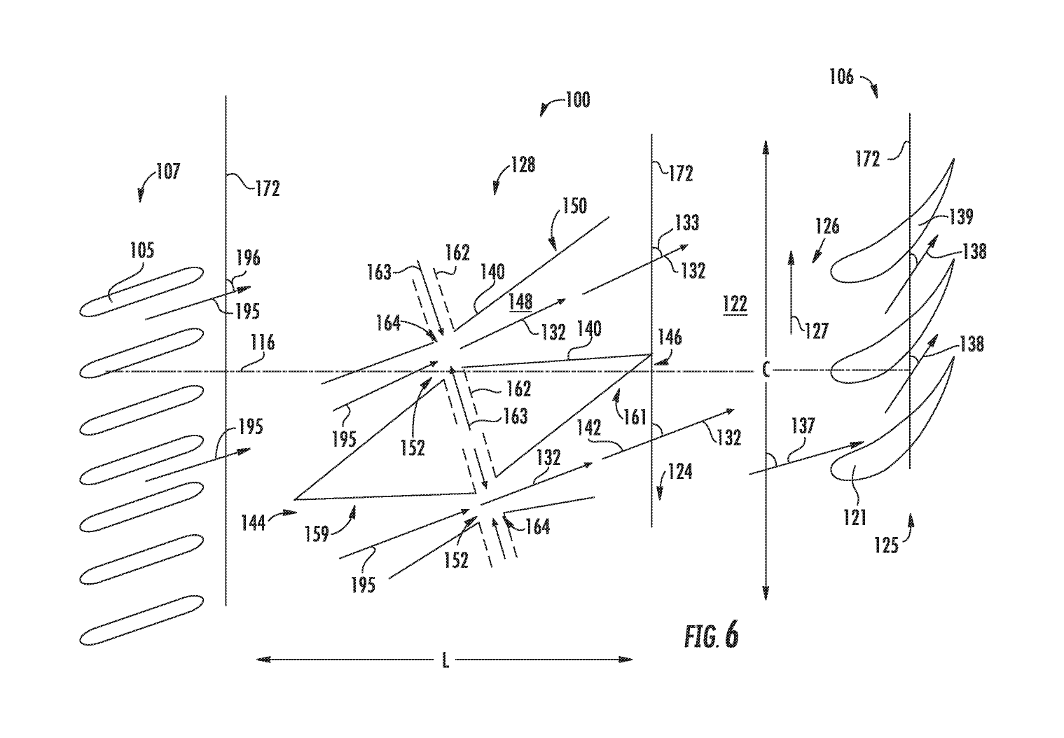

Referring now to FIG. 6, another exemplary embodiment of a portion of the propulsion system 10 is generally provided. The propulsion system 10 is configured substantially similarly as described in regard to FIGS. 1-4. However, in FIG. 6, a plurality of RDC inlet airfoils 105 is disposed at an RDC inlet 107 of the RDC system 100 downstream of the inlet section 104 and upstream of the nozzle assembly 128.

In various embodiments, the plurality of RDC inlet airfoils 105 defines a pre-diffuser or exit guide vane structure of the RDC system 100. In other embodiments, the plurality of RDC inlet airfoils 105 defines a guide vane structure of the RDC system 100 disposed within the exhaust section 106 defining a turbine section 29, such as generally provided in FIG. 4.

In various embodiments, the plurality of RDC inlet airfoils 105 defines an inlet angle 196 relative to the reference plane 172. In one embodiment, the inlet angle 196 is greater than zero degrees and approximately 80 degrees or less relative to the reference plane 172. In another embodiment, the inlet angle 196 and the nozzle angle 133 are within approximately 20 degrees relative to one another. In yet another embodiment, the inlet angle 196 and the nozzle angle 133 are approximately equal.

Referring now to FIG. 7, still another exemplary embodiment of a portion of the propulsion system 10 is generally provided. The propulsion system 10 is configured substantially similarly as described in regard to FIGS. 1-6. However, in FIG. 7, the RDC system 100 is shown disposed within the exhaust section 106 such as to define a reheat cycle of the propulsion system 10. In one embodiment, such as shown in FIG. 7, the RDC system 100 is disposed upstream of and in direct fluid communication with the first turbine rotor 131 disposed downstream of the RDC system 100. The RDC inlet airfoils 105 may be a rotating plurality of airfoils (e.g., blades or rotors) disposing the combustion gases 138 (i.e., combustion gases 138 from an upstream combustion section, such as another RDC system 100) at an inlet angle 196 greater than zero degrees and approximately 80 degrees or less relative to the reference plane 172. In other embodiments, the RDC inlet airfoils 105 may define a plurality of stationary or static airfoils (e.g., vanes) disposing the combustion gases 138 at an inlet angle 196 such as described in regard to FIG. 6.

Referring back to FIG. 4, and in conjunction with the various embodiments shown and described in regard to FIGS. 5-7, in various embodiments, the RDC system 100 may further be disposed within the exhaust section 106 defining a high pressure turbine 28 and a low pressure turbine 30 of the turbine section 29. The RDC system 100 may define an inter-turbine reheat system between the high pressure turbine 28 and the low pressure turbine 30, such as further described in regard to FIG. 7. In still another embodiment, the RDC system 100 may be disposed downstream of the exhaust section 106 or turbine section 29 to define an afterburner. In such an embodiment, the RDC system 100 may include the nozzle assembly 128 such as described herein. The RDC system 100 may further include one or more combinations of an RDC inlet airfoil 105 (shown and described in regard to FIGS. 6-7), the first turbine nozzle 125 (shown and described in regard to FIGS. 5-6), or combinations thereof

Referring now to FIG. 8, an exemplary forward cross sectional view of the RDC system 100 is generally provided. The exemplary embodiment shown in FIG. 8 may be configured substantially similarly to those described in regard to FIGS. 1-7. The exemplary embodiment generally provided in FIG. 8 shows a plurality of the nozzle assembly 128 disposed in adjacent radial arrangement relative to the longitudinal centerline 116.

Referring now to FIG. 9, another exemplary forward cross sectional view of the RDC system 100 is generally provided. The exemplary embodiment shown in FIG. 9 may be configured substantially similarly to those described in regard to FIGS. 1-7. The exemplary embodiment generally provided in FIG. 9 shows an annular nozzle assembly 128 in which a plurality of the fuel injection ports 162 are disposed at circumferential locations within an annular throat 152 of each nozzle assembly 128. The embodiment shown in FIG. 9 may further include a plurality of the nozzle assembly 128 disposed in adjacent radial arrangement relative to the longitudinal centerline 116 of the propulsion system 10. The annular configuration of the nozzle assembly 128 generally provided may further include a plurality of nozzle wall 150 extended along the longitudinal direction L (shown in FIGS. 1-7) at a nozzle angle 133 such as to induce the bulk swirl of fuel/oxidizer mixture 132 and combustion gases 138 through the combustion chamber 122 (shown in FIGS. 1-7).

Embodiments of the propulsion system 10 including the bulk swirl RDC system 100 generally provided herein may increase a bulk swirl of the combustion gases 138 within the combustion chamber 122 of the RDC system 100, thereby reducing a length of the turbine nozzle or altogether eliminating the turbine nozzle, thereby enabling direct fluid communication of the combustion gases 138 from the combustion chamber 122 to the first turbine rotor 131, and reducing a length of the propulsion system 10. Reducing the length of or eliminating the turbine nozzle may improve overall propulsion system efficiency and performance, such as by reducing part counts, length, weight, and improving thermodynamic efficiency by reducing an amount of cooling oxidizer removed from combustion and energy release.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A propulsion system defining a radial direction extended from a longitudinal centerline extended along a longitudinal direction, and a circumferential direction relative to the longitudinal centerline, the propulsion system comprising:
a rotating detonation combustion (RDC) system defining a plurality of fuel-oxidizer mixing nozzles each defined by a converging-diverging nozzle wall defining a nozzle flowpath, wherein the nozzle wall defines a throat and a lengthwise direction extended between a nozzle inlet and nozzle outlet along the lengthwise direction, and wherein the longitudinal centerline of the propulsion system and the radial direction together define a reference plane, and wherein the lengthwise direction of the nozzle intersects the reference plane and defines a nozzle angle greater than zero degrees and approximately 80 degrees or less relative to the reference plane.

2. The propulsion system of claim 1, wherein the RDC system further comprises an annular outer wall defining at least in part a combustion chamber downstream of the plurality of nozzles.

3. The propulsion system of claim 2, wherein the RDC system defines the outer wall generally concentric to the longitudinal centerline of the propulsion system.

4. The propulsion system of claim 2, further comprising:
a turbine nozzle disposed downstream of the combustion chamber, wherein the turbine nozzle comprises a plurality of turbine nozzle airfoils defining an exit angle relative to the reference plane.

5. The propulsion system of claim 4, wherein the exit angle of the plurality of turbine nozzle airfoils is configured to a desired circumferential direction relative to an exhaust section of the propulsion system.

6. The propulsion system of claim 4, wherein the exit angle and the nozzle angle are within approximately 20 degrees relative to one another.

7. The propulsion system of claim 4, wherein the exit angle and the nozzle angle are approximately equal.

8. The propulsion system of claim 4, wherein the plurality of turbine nozzle airfoils defines a turbine nozzle inlet angle, and wherein the inlet angle is less than or approximately equal to the exit angle.

9. The propulsion system of claim 4, wherein the plurality of turbine nozzle airfoils defines an inlet angle, and wherein the inlet angle is approximately equal to or less than the nozzle angle.

10. The propulsion system of claim 1, wherein the RDC system defines an RDC inlet comprising a plurality of RDC inlet airfoils defining an inlet angle relative to the reference plane.

11. The propulsion system of claim 10, wherein the inlet angle of the RDC inlet airfoils is greater than zero degrees and approximately 80 degrees or less relative to the reference plane.

12. The propulsion system of claim 10, wherein the inlet angle and the nozzle angle are within approximately 20 degrees relative to one another.

13. The propulsion system of claim 1, wherein each nozzle of the RDC system further defines a fuel injection port disposed approximately at the throat of each nozzle, wherein the fuel injection port is configured to flow a fuel to the nozzle flowpath.

14. A gas turbine engine defining a radial direction extended from a longitudinal centerline extended along a longitudinal direction, and a circumferential direction relative to the longitudinal centerline, the gas turbine engine comprising:
a rotating detonation combustion (RDC) system defining a plurality of fuel-oxidizer mixing nozzles each defined by a converging-diverging nozzle wall defining a nozzle flowpath, wherein the nozzle wall defines a throat and a lengthwise direction extended between a nozzle inlet and nozzle outlet along the lengthwise direction, and wherein the longitudinal centerline of the propulsion system and the radial direction together define a reference plane, and wherein the lengthwise direction of the nozzle intersects the reference plane and defines a nozzle angle greater than zero degrees and approximately 80 degrees or less relative to the reference plane, and wherein the RDC system further defines an annular outer wall defining at least in part a combustion chamber downstream of the plurality of nozzles, wherein the combustion chamber defines a combustion inlet proximate to the plurality of nozzles and a combustion outlet downstream thereof;
a first turbine rotor at the combustion outlet of the RDC system, wherein the first turbine rotor is in direct fluid communication with the combustion chamber.

15. The gas turbine engine of claim 14, wherein the nozzle angle is greater than approximately 65 degrees and less than approximately 80 degrees, inclusively.

16. The gas turbine engine of claim 14, wherein each nozzle of the RDC system further defines a fuel injection port disposed approximately at the throat of each nozzle, wherein the fuel injection port is configured to flow a fuel to the nozzle flowpath.

17. The gas turbine engine of claim 14, wherein the first turbine rotor is configured to rotate co-directional to a direction of bulk swirl of fuel/oxidizer mixture.

18. The gas turbine engine of claim 14, wherein the RDC system defines an RDC inlet comprising a plurality of RDC inlet airfoils defining an inlet angle relative to the reference plane.

19. The gas turbine engine of claim 17, wherein the inlet angle of the RDC inlet airfoils is greater than zero degrees and approximately 80 degrees or less relative to the reference plane.

20. The gas turbine engine of claim 19, wherein the inlet angle and the nozzle angle are within approximately 20 degrees relative to one another.
